(19) United States
(12) Patent Application Publication
(10) Pub. No.: US 2026/0138197 A1
(43) Pub. Date: May 21, 2026

(54) CLAMPING BOLT AND CUTTING ASSEMBLY HAVING A CLAMPING BOLT

(71) Applicant: Kennametal Inc., Latrobe, PA (US)

(72) Inventors: Duc Phuong HAN, Fürth (DE); Igor KAUFMANN, Nuemberg (DE); Dominik SCHMID, Fürth (DE)

(21) Appl. No.: 19/395,984

(22) Filed: Nov. 20, 2025

(30) Foreign Application Priority Data
Nov. 21, 2024 (DE) 1020241342056

(51) Int. Cl. B23C 5/22; F16B 35/04

(52) U.S. Cl. CPC B23C 5/2208; F16B 35/041; B23C 2210/165

(57) ABSTRACT

A clamping bolt for fastening a cutting insert to a cutting tool has a head portion, a clamping portion with a clamping surface, and a transition portion. The clamping bolt has at least one of the following features: the head portion has a protective contour with several protrusions and/or several indentations on an axial front surface; the clamping portion has a recess with a reinforcing structure comprising a rib; the transition portion has a non-circular cross-section perpendicular to the longitudinal extension of the transition portion. A cutting assembly with such a clamping bolt is also provided.

The invention relates to a clamping bolt for fastening a cutting insert to a cutting tool, comprising a head portion at a first longitudinal end of the clamping bolt, a clamping portion arranged at a second longitudinal end of the clamping bolt opposite the first longitudinal end and having a clamping surface as an engagement surface for a fastening element, and a transition portion connecting the head portion to the clamping portion. Furthermore, the invention relates to a cutting assembly with a cutting tool and a cutting insert which is fastened to the cutting tool by means of such a clamping bolt.

Such clamping bolts and cutting assemblies are known.

The clamping bolts fix the cutting inserts to the cutting tool and are subjected to high loads during operation of the cutting tool, which limits their service life.

The task of the invention is to provide a clamping bolt that is particularly resistant and therefore has a long service life. The invention also aims to provide a cutting assembly with such a clamping bolt.

The task is solved by a clamping bolt for fastening a cutting insert to a cutting tool, comprising a head portion at a first longitudinal end of the clamping bolt, a clamping portion arranged at a second longitudinal end of the clamping bolt opposite the first longitudinal end and having a clamping surface as an engagement surface for a fastening element, and a transition portion connecting the head portion to the clamping portion. The clamping bolt has at least one of the following features: the head portion has a protective contour on an axial front surface at the first longitudinal end, wherein the protective contour has a plurality of protrusions and/or a plurality of indentations; the clamping portion has a recess with a reinforcing structure that has a rib; the transition portion has a non-circular cross-section perpendicular to the longitudinal extension of the transition portion.

According to the invention, it was recognized that certain portions of the clamping bolt are subjected to particularly high loads and that the clamping bolt can be designed to be particularly robust and resistant by providing at least one of these portions with the corresponding feature.

Due to the protrusions, the head portion at the front end, which is usually exposed during operation, has more material, making the head portion more stable and resistant to passing chips. The indentations mean that the head portion provides less friction surface for passing chips, thereby reducing wear. Furthermore, cooling lubricant can be retained or collected in the indentations during operation, improving chip removal. The protective contour thus improves chip removal and protects the clamping bolt from damage.

The rib of the reinforcing structure distributes loads favorably across the clamping portion, giving the clamping portion particularly high strength.

Because the transition portion has a non-circular cross-section, the transition portion can have a particularly large cross-sectional area and thus be designed to be particularly stable.

According to one aspect, the protective contour is not part of a screw head drive. Therefore, there is no indentation in the sense of a slot for a screwdriver or an Allen key.

Furthermore, according to a further aspect, the clamping bolt has no screw head drive.

In one embodiment, the protrusions of the protective contour are arranged in an edge region, thereby effectively reinforcing this outer region, which is exposed to particularly high loads.

In addition or alternatively, the indentations of the protective contour may be arranged in a central region of the front surface, thereby particularly effectively reducing friction with chips flowing past the head portion.

Furthermore, it may be provided that the protrusions of the protective contour and/or the indentations of the protective contour are arranged rotationally symmetrical to an axis that is perpendicular to the front surface. This design significantly promotes the effective flow of chips and reduces the risk of chips becoming jammed in the protective contour.

In another embodiment, the transition portion has an oval or elliptical cross-section perpendicular to the longitudinal extension of the transition portion, whereby the transition portion is designed to be particularly stable.

In this case, the transition portion can have an elliptical cross-section with half-axes a and b, wherein the length of a is at least 120% of the length of b. Compared to a conventional clamping bolt, which has a circular cross-section with radius b, the transition portion of the clamping bolt according to the invention has a significantly larger cross-sectional area and is thus designed to be much more stable.

According to one aspect, the transition portion is bent, and the central longitudinal axis of the head portion runs at an angle greater than 0°relative to the central longitudinal axis of the clamping portion. In this case, the longitudinal extension of the transition portion runs along the curve of the transition portion. Due to the bent transition portion, the head portion has a different orientation than the clamping portion. This allows the clamping bolt and the associated fastening element to be arranged in a particularly advantageous manner in the cutting tool, for example in a manner that facilitates the assembly of the cutting insert and/or the manufacture of the cutting tool.

In this case, the angle may be greater than 5°.

Furthermore, it may be provided that the rib has a longitudinal extension that runs parallel to the longitudinal extension of the clamping portion. This design has the advantage that the loads are distributed particularly effectively over the longitudinal extension of the clamping portion by the rib.

According to one embodiment, the rib extends longitudinally toward the clamping surface. This means that its height decreases. In this way, the rib can extend over a particularly large longitudinal section without blocking the region through which the fastening element extends to the clamping surface when a cutting insert is fastened to the cutting tool by means of the clamping bolt and the fastening element.

In addition or alternatively, the rib may taper longitudinally toward one end facing the clamping surface to form a corresponding recess for the fastening element.

In a further embodiment, the head portion and the clamping portion each have a rotationally symmetrical portion via which they adjoin the transition portion. This makes the clamping bolt particularly material-efficient.

According to the invention, a cutting assembly with a cutting tool and a cutting insert is also provided to solve the above-mentioned problem, which is fastened to the cutting tool by means of a clamping bolt according to the invention with the aforementioned advantages.

Further advantages and features will emerge from the following description and from the accompanying drawings. The figures show:

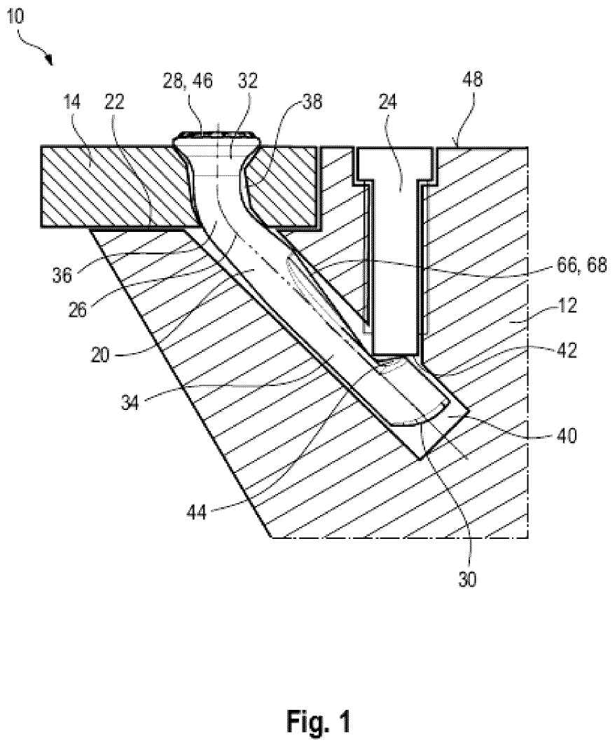

FIG. 1 in a schematic sectional view, a cutting assembly according to the invention with a clamping bolt according to the invention,

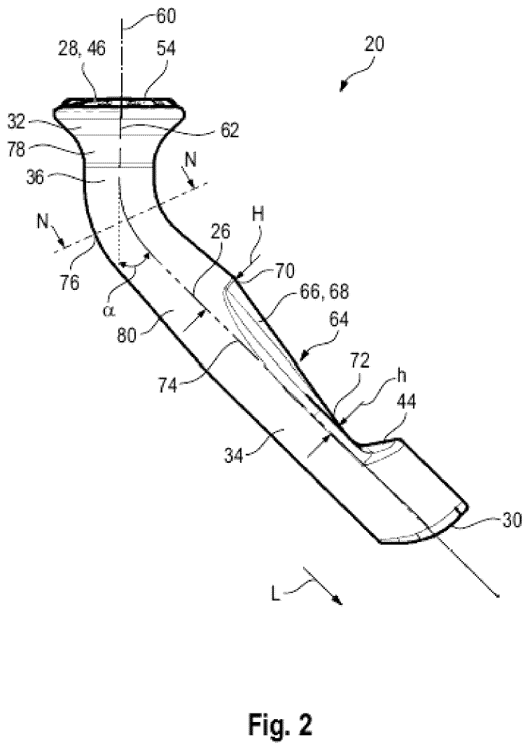

FIG. 2 in a side view of the clamping bolt from FIG. 1,

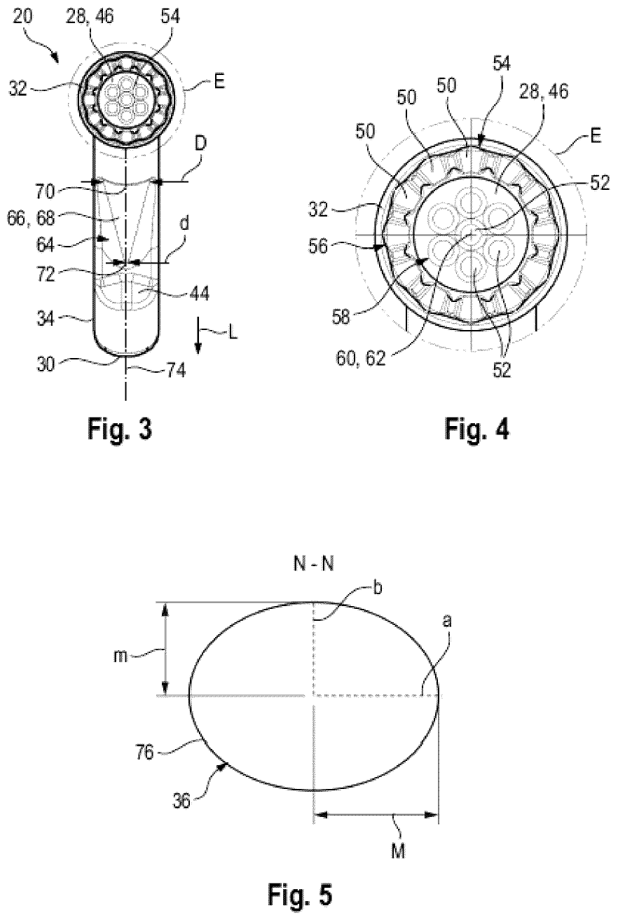

FIG. 3 in a top view of the clamping bolt from FIG. 1,

FIG. 4 in a detailed view of a head portion of the clamping bolt from FIG. 3,

FIG. 5 a transition portion of the clamping bolt in a sectional view along the plane N-N in FIG. 2, and

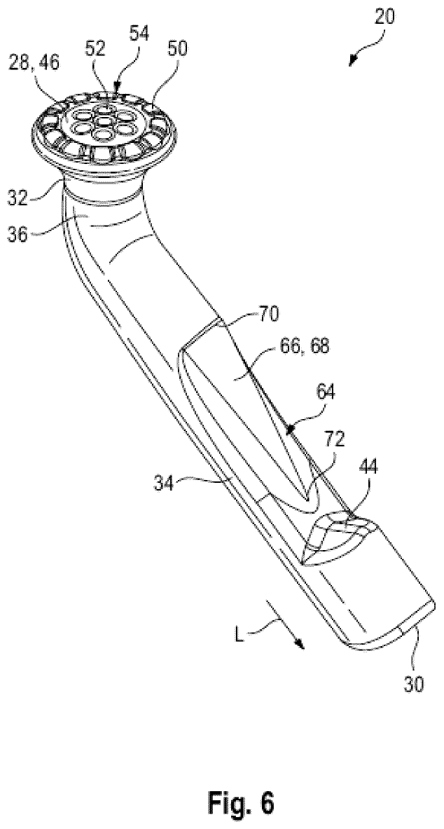

FIG. 6 in a perspective view of the clamping bolt from FIG. 1.

The detailed description below in conjunction with the accompanying drawings, in which like numerals refer to like elements, is intended as a description of various embodiments of the disclosed subject-matter and is not intended to show the individual embodiments. Any embodiment described in this disclosure serves as an example or for illustrative purposes only and should not be construed as being preferred or advantageous over other embodiments.

All features disclosed below in relation to the exemplary embodiments and/or accompanying figures can be combined, alone or in any sub-combination, with features of aspects of the present disclosure, including features of preferred embodiments, provided that the resulting combination of features is sensible to those skilled in the art.

FIG. 1 shows a cutting assembly 10 with a cutting tool 12, a cutting insert 14, and a clamping bolt 20 in an assembled state.

The cutting tool 12 is, for example, a milling tool such as a milling cutter.

The cutting insert 14 is arranged in a pocket 22 of the cutting tool 12 and fastened to the cutting tool 12 by means of the clamping bolt 20 and a fastening element 24.

The clamping bolt 20 extends along its longitudinal extension 26 from a first longitudinal end 28 to an opposite second longitudinal end 30.

The longitudinal extension 26 is formed by a curve with continuous curvature, which extends through all the centers of the cross-sections of the clamping bolt 20 from the first longitudinal end 28 to the second longitudinal end 30. The cross-sections are perpendicular to the longitudinal extension 26.

Furthermore, the clamping bolt 20 has a head portion 32, which is arranged at the first longitudinal end 28, a clamping portion 34, which is arranged at the second longitudinal end 30, and a transition portion 36, which connects the head portion 32 to the clamping portion 34.

In the embodiment shown, the fastening element 24 is a screw that is screwed to the cutting tool 12.

In principle, the fastening element 24 can be of any design and connected to the cutting tool 12 in any adjustable manner.

In the assembled state, the head portion 32 is arranged in a through hole 38 of the cutting insert 14, while the clamping portion 34 extends into a receptacle 40 in the cutting tool 12.

The fastening element 24 engages with an axial end 42 on a clamping surface 44 of the clamping portion 34 on the clamping bolt 20 and pretensions it.

In this way, the cutting insert 14 is clamped in the pocket 22 by means of the clamping bolt 20 and thus fixed to the cutting tool 12.

In this context, the head portion 32 has an axial front surface 46 at the first longitudinal end 28, which forms part of the outer side 48 of the cutting assembly 10.

When cutting assembly 10 is in operation, i.e., when a workpiece is being machined by cutting assembly 10, the outer side 48 forms one side of the cutting assembly 10 over which chips can flow.

The same applies to cooling lubricant if it is used during operation of the cutting assembly 10.

The design of the clamping bolt 20 is explained in more detail below with reference to FIGS. 2 to 6.

The head portion 32 has twelve protrusions 50 (see FIG. 4) and seven indentations 52 on the axial front surface 46, which together form a protective contour 54 of the head portion 32.

In an alternative embodiment, the protective contour 54 may have any number of protrusions 50 and/or indentations 52, but at least two protrusions 50 or at least two indentations 52.

The protrusions 50 are formed, for example, by rounded elevations.

The indentations 52 are, for example, round, trough-shaped indentations.

In principle, the protrusions 50 and the indentations 52 can each be designed as desired.

In the embodiment shown, the protrusions 50 are arranged in an outer, annular edge region 56 of the axial front surface 46, while the indentations 52 are arranged in the central region 58 of the axial front surface 46.

In the present case, the protrusions 50 and the indentations 52 are each arranged rotationally symmetrical about an axis 60 that is perpendicular to the axial front surface 46.

In the exemplary embodiment, the axis 60 coincides with the central longitudinal axis 62 of the head portion 32.

In an alternative embodiment, the protrusions 50 and the indentation 52 may each be arranged arbitrarily on the axial front surface 46, for example, each rotationally symmetrical about any axis.

The clamping portion 34 has a lateral recess 64 (see FIG. 2) which adjoins the clamping surface 44 and has a reinforcing structure 66 in the form of a rib 68.

The rib 68 extends in the longitudinal direction L from an end 70 facing the transition portion 36 to an end 72 facing the clamping surface 44. This means that the longitudinal extension of the rib 68 runs parallel to the longitudinal extension 26 of the clamping portion 34.

In the embodiment shown, the radial height of the rib 68 measured relative to the central longitudinal axis 74 of the clamping portion 34 continuously decreases in the longitudinal direction L from a radial height H at the end 70 facing the transition portion 36 to a radial height h at the end 72 facing the clamping surface 44. In other words, the rib 68 tapers in the longitudinal direction L toward the clamping surface 44 (see FIG. 6).

Furthermore, the width (see FIG. 3) of the rib 68 continuously decreases in the longitudinal direction L from a width D at the end 70 facing the transition portion 36 to a width d at the end 72 facing the clamping surface 44. In other words, the rib 68 tapers in the longitudinal direction L toward the clamping surface 44.

In principle, the rib 68 can be designed in any way.

Furthermore, in an alternative embodiment, the reinforcement structure 66 can be designed in any way as long as it has a rib 68.

The transition portion 36 has, in a section perpendicular to the longitudinal extension 26, an elliptical cross-section 76 (see FIG. 5) with a major half-axis a and a minor half-axis b.

The major half-axis a has a length M, which is 125% of the length m of the minor half-axis b.

The cross-sectional area (A=πab) of the elliptical cross-section 76 is therefore 25% larger than a circular area (A=πb²) with the radius b.

In principle, the length L of the major half-axis a can be any multiple of the length m of the minor half-axis b, for example at least 1.2.

In an alternative embodiment, the transition portion 36 may have any non-circular cross-section 76 perpendicular to the longitudinal extension 26, for example an oval one.

Furthermore, in the embodiment shown, the transition portion 36 is bent (see FIG. 2), whereby the central longitudinal axis 62 of the head portion 32 runs at an angle α of 30° to the central longitudinal axis 74 of the clamping portion 34.

In principle, the angle α can have any value greater than 0°, for example greater than 5°.

Alternatively, the angle α can be 0°and the transition portion 36 can be straight, i.e., not bent.

In this context, the transition portion 36 adjoins a portion 78 of the head portion 32 on the one hand and a portion 80 of the clamping portion 34 on the other hand, which are each designed to be rotationally symmetrical with respect to the central longitudinal axis 62, 72 of the head portion 32 and the clamping portion 34, respectively.

In this way, a clamping bolt 20 and a cutting assembly 10 with a clamping bolt 20 are provided, which is designed to be particularly robust and has a long service life.

1. A clamping bolt for fastening a cutting insert to a cutting tool, comprising a head portion at a first longitudinal end of the clamping bolt, a clamping portion arranged at a second longitudinal end of the clamping bolt opposite the first longitudinal end and having a clamping surface as an engagement surface for a fastening element, and a transition portion connecting the head portion to the clamping portion, wherein the clamping bolt comprises at least one of the following features:
the head portion has a protective contour on an axial front surface at the first longitudinal end, wherein the protective contour has a plurality of protrusions and/or a plurality of indentations;
the clamping portion has a recess with a reinforcing structure comprising a rib;
the transition portion has a non-circular cross-section perpendicular to the longitudinal extension of the transition portion.

2. The clamping bolt according to claim 1, wherein the protrusions of the protective contour are arranged in an edge region and/or the indentations of the protective contour are arranged in a central region of the front surface.

3. The clamping bolt according to claim 1, wherein the protrusions of the protective contour and/or the indentations of the protective contour are arranged rotationally symmetrical to an axis that is perpendicular to the front surface.

4. The clamping bolt according to claim 1, wherein the transition portion has an oval or elliptical cross-section perpendicular to the longitudinal extension of the transition portion.

5. The clamping bolt according to claim 4, wherein the transition portion has an elliptical cross-section with half-axes a and b, wherein the length of a is at least 120% of the length of b.

6. The clamping bolt according to claim 1, wherein the transition portion is bent and the central longitudinal axis of the head portion runs at an angle greater than 0° relative to the central longitudinal axis of the clamping portion.

7. The clamping bolt according to claim 1, wherein the clamping portion has the recess with the reinforcing structure comprising the rib, and the rib has a longitudinal extension that runs parallel to the longitudinal extension of the clamping portion.

8. The clamping bolt according to claim 7, wherein the rib extends in the longitudinal direction towards the clamping surface.

9. The clamping bolt according to claim 7, wherein the rib tapers in the longitudinal direction towards an end facing the clamping surface.

10. The clamping bolt according to claim 1, wherein the head portion and the clamping portion each have a rotationally symmetrical portion via which they adjoin the transition portion.

11. (canceled)

12. A cutting assembly comprising:
a cutting tool;
a cutting insert; and
a clamping bolt fastening the cutting insert to the cutting tool comprising a head portion at a first longitudinal end of the clamping bolt, a clamping portion arranged at a second longitudinal end of the clamping bolt opposite the first longitudinal end and having a clamping surface as an engagement surface for a fastening element, and a transition portion connecting the head portion to the clamping portion, wherein the clamping bolt comprises at least one of the following features:
the head portion has a protective contour on an axial front surface at the first longitudinal end, wherein the protective contour has a plurality of protrusions and/or a plurality of indentations;
the clamping portion has a recess with a reinforcing structure comprising a rib;
the transition portion has a non-circular cross-section perpendicular to the longitudinal extension of the transition portion.
